(19) United States
(12) Patent Application Publication
(10) Pub. No.: US 2004/0100869 A1
(43) Pub. Date: May 27, 2004

(54) Push-piece control device for a watch

(76) Inventor: Pierre-Andre Finazzi, La Chaux-de-Fonds (CH)

Correspondence Address: YOUNG & THOMPSON, 745 SOUTH 23RD STREET 2ND FLOOR, ARLINGTON, VA, 22202

(21) Appl. No.: 10/276,557

(22) PCT Filed: May 10, 2001
(86) PCT No.: PCT/CH01/00289

(30) Foreign Application Priority Data
May 18, 2000 (CH) 998/00

(51) Int. Cl. G04F 8/00; G04F 10/00; G04B 29/00

(52) U.S. Cl. 368/1; 368/319

(57) ABSTRACT

The invention concerns a push-piece control device for a watch comprising a case (10) provided with a middle (12), an arbor (16) integral with a crown (20) and mounted pivoting in the middle (12) and a push-piece (18) mounted sliding and coaxial to the arbor (16). The invention is characterised in that it further comprises a lever (32) mounted pivoting on said case (10) by one of its ends (32a), mobile in a plane substantially parallel to the watch plane, including, in its median part (32b), a contact point designed to co-operate with said push-piece (18) and, at its other end (32c), a concave control portion.

The present invention relates to push-piece control devices for watches provided with a crown for setting the time and, when they include a mechanical power source, for winding the main spring of the barrel. More precisely, the invention concerns watches including a push-piece coaxial with the crown. Such watches are, for example, disclosed and shown in the work entitled “Le Chronographe”, B. Humbert, Scriptar S A, Lausanne 1955. They are usually chronographs or counters.

Within the scope of the present description, the positions of the various components disposed on the periphery of the watch are defined with reference to the position that an hour hand would occupy at a given time.

The fact of placing the push-piece concentrically to the crown, as proposed in Swiss Patent document No. 226715 simplifies the structure of the case and can give the watch a particular look. In most cases the crown is at 3 o'clock. This position is ergonomically favorable for winding and setting the time of the watch. However, applying pressure to a push-piece occupying this position requires unnatural movements. The object of the present invention is to overcome this drawback.

The device of the invention is thus characterized in that it further includes a lever mounted so as to pivot on said case via one of its ends, mobile in a substantially parallel plane to the plane of the watch, including, in its median part, a contact point intended to co-operate with the push-piece and, at its other end, a control portion, of concave shape.

The combination of a lever with a push-piece is also known, particularly from Patent document Nos. U.S. Pat. No. 3,759,033, EP 0443087 or CH 13865/75, which disclose chronographs or counters wherein the push-pieces are integrated in the case.

In order for the device to fully fulfill its function, the lever must be securely fixed to the case and disposed so as to avoid any inadvertent actuation. This is why, in a first embodiment, the push-piece includes a button partially engaged in the crown and forming a protruding portion. The case further includes a stirrup-shaped piece straddling the crown and the push-piece. This stirrup-shaped piece is fixed by its two ends to the middle part. The lever is mounted so as to pivot on the stirrup-shaped piece, and extends between the straddling portion and the push-piece, then beyond the stirrup-shaped piece to form the control portion.

Advantageously, the case includes a tube in which the push-piece and the stem are arranged, whereas the stirrup-shaped piece is provided with a clamp fixed to its two ends and surrounding and gripping the tube.

According to a second embodiment, also allowing the lever to be securely fixed to the case and any inadvertent maneuver to be avoided, the push-piece includes an annular portion inserted between the crown and the middle part and the lever is inserted between this annular portion and the crown.

In order to assure secure and reliable fixing, the middle part is provided with a stud onto which the lever is mounted so as to pivot.

Such solutions are particularly advantageous when the crown is at 9 o'clock and the control portion is at approximately 8 o'clock, as the protruding elements are in a well protected part, since they are placed on the elbow side. Consequently, the risk of catching on something is substantially reduced.

Other features and advantages of the invention will appear from the following description, made with reference to the annexed drawing, in which:

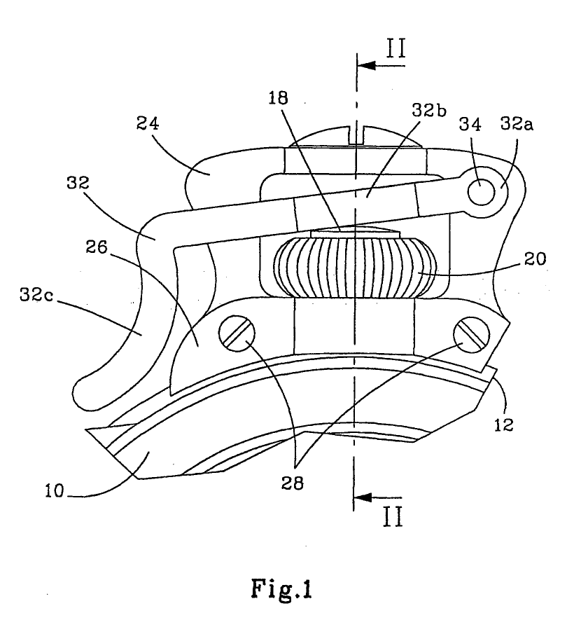

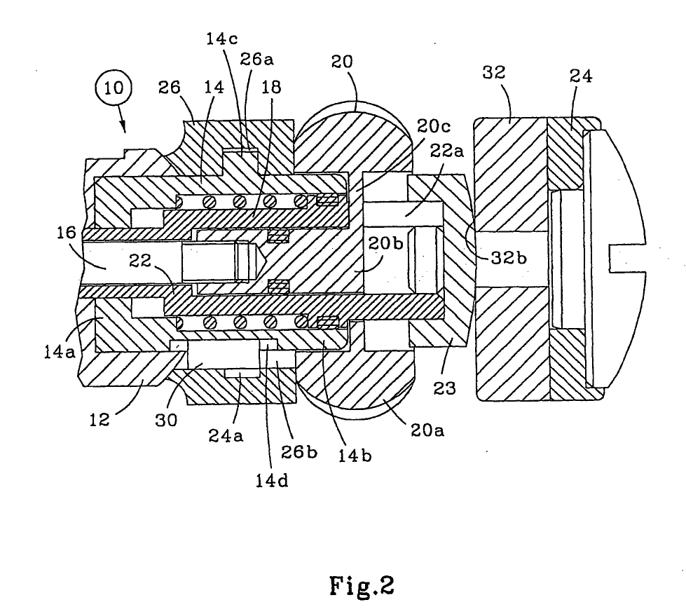

FIGS. 1 and 2 show a control device according to a first embodiment of the invention, seen respectively from above and in cross-section along the line II-II of FIG. 1, and

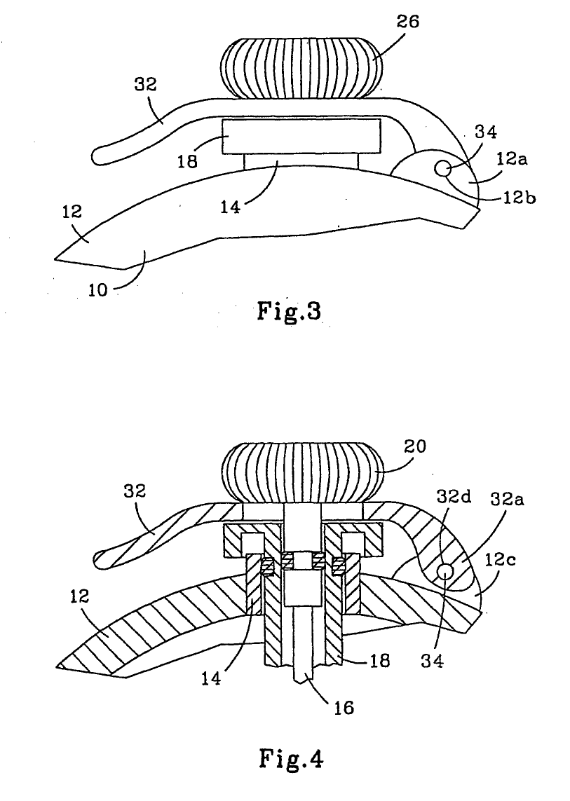

FIGS. 3 and 4 show a device according to a second embodiment, seen from above in plane and cross-sectional views.

FIGS. 1 and 2 show a watch portion including a case 10 including notably a middle part 12 and a tube 14 driven into a hole in the middle part. A watch movement, not shown in the drawing, is housed in case 10. It is of the chronograph type, controlled by a stem 16 and a push-piece 18.

Tube 14 is formed of a first portion 14a, engaged in middle part 12, and a second portion 14b extending outside the middle part. Second portion 14b includes an annular flange 14c and a groove 14d whose orientation is parallel to the axis of the tube.

Stem 16 carries, at its external end, a crown 20 for setting the time and, in the case of a mechanical watch, for rewinding the power source. Crown 20 includes a first external part 20a of annular shape, a second part 20b, forming a hub secured to stem 16 and a third intermediate part, formed of three radially oriented spokes 20c connecting hub 20b to part 20a.

Push-piece 18 includes a tubular part 22 and a cap 23 secured to the, end of part 22 to close the hole located outside case 10. Tubular part 22 is provided, in its portion in proximity to cap 23, with three grooves 22a extending over the whole of its part disposed outside tube 14, in which spokes 20c are engaged. It should be noted that the axial distance from hub 20b and spokes 20c to cap 23 is of the order of approximately 1 mm. Consequently, it is possible to assure a sufficient movement of the push-piece to control the mechanism with which it is associated and of the crown during the time setting function.

Cap 23 projects from crown 20 to form a button intended to apply pressure to control a function of the watch.

A stirrup-shaped piece 24, forming a loop around crown 16 and push-piece 18, is fixed onto tube 14 by a clamp 26, secured to stirrup-shaped piece 24 by screws 28. More precisely, stirrup-shaped piece 24 and clamp 26 include an annular groove identified by the letter a in which flange 14a is engaged, which axially blocks stirrup-shaped piece 24. A hollow 26b is made in clamp 26, parallel to groove 14d, of the same width and the same length. A key 30 is disposed in the housing formed by groove 14d and hollow 26b, thus blocking the stirrup-shaped piece in rotation.

Stirrup-shaped piece 24 carries a lever 32, mounted so as to pivot via one of its ends 32a by means of a pin 34 engaged in holes in lever 32 and stirrup-shaped piece 24. Lever 32 is mobile in a substantially parallel plane to the plane of the watch, which is defined by the surface of its dial.

Lever 32 includes, in its median part 32b, a contact point for co-operating with push-piece 18, by abutting cap 23. The other end 32c constitutes a control portion, of concave shape.

The control device further includes a spring for returning push piece 14 and sealing gaskets to prevent water penetrating the movement. These parts will not be described in more detail, since they do not form part of the invention.

The device described allows the following functions to be fulfilled.

When the device is in the position shown in the drawing, the application of a torque on crown 20 has the effect of rotating stem 16, which winds the power source of the watch if it is a mechanical timepiece. This rotational movement also causes push-piece 18 to rotate, without any consequences.

In order to set the time of the watch, one need only pull out crown 20. This is possible, because of the play comprised between parts 20b and 20c of crown 20 and cap 23. By then rotating crown 20, the position of the hands is corrected, owing to a well known mechanism associated with the watch movement.

Push-piece 18 allows a complementary function to be controlled, for example a chronograph, a first application of pressure causing the chronograph mechanism to start, a second causing it to stop and a third resetting the hands to zero. In order to control these functions, one need only press on end 32c of lever 32 with a finger. It should be noted that the concave shape of this end allows the finger responsible for applying pressure to be well positioned.

The presence of this lever 32 means that the force to be applied to control the push-piece is not oriented along the axis of the push-piece. This dislocation is advantageous. Indeed, the timesetting crown is generally located at 3 o'clock, which corresponds to the most favorable position for rewinding the watch. This offset is, however, inconvenient for applying pressure. Further, since the push-piece projects from the crown, there is a risk of it becoming caught.

This risk is removed by placing the crown at 9 o'clock. Moreover, the presence of the lever allows the orientation of the force to be applied to be shifted along the 8 o'clock-2 o'clock direction, which is much more favorable.

In the embodiment of the device shown in FIGS. 3 and 4, one can again see case 10, middle part 12, tube 14, stem 16, push-piece 18, crown 20 and lever 32. In this configuration, crown 20 is on the outside, whereas push-piece 18, inserted between tube 14 and stem 16, is of annular shape and stops, axially, beyond tube 14, but leaving, between it and the crown, a space in which lever 32 is housed.

Middle part 12 includes a stud 12a provided with a hole 12b and a slot 12c. End 32a of lever 32, pierced with a hole 32d, is slipped into slot 12c and mounted so as to pivot on the stud by means of a pin 34 forcibly engaged in one or other of holes 12b and 32d.

This second embodiment allows the push-piece to be placed in a position that is normally inaccessible to pressure from a finger, while considerably simplifying the structure of the assembly, and more particularly of the crown and the push-piece. Moreover, it is no longer necessary to have a stirrup-shaped piece to hold the lever, the latter being held by the crown.

1. Control device with a push-piece for a watch of the type including a case (10) provided with a middle part (12), a stem (16) secured to a crown (20) and mounted so as to pivot in the middle part (12) and a push-piece (18) mounted so as to slide and coaxial with the stem (16), characterized in that it further includes a lever (32) mounted so as to pivot on said case (10) by one of its ends (32a), mobile in a substantially parallel plane to the plane of the watch, including, in its median part (32b), a contact point for co-operating with said push-piece (18) and, at its other end (32c), a control portion, of concave shape.

2. Device according to claim 1, characterized in that said push-piece forms, via its external end, a protruding button (23) partially engaged in the crown (20), in that the case (10) further includes a stirrup-shaped piece (24) straddling the crown (20) and the push-piece (18) and fixed by its two ends to the middle part (12) and in that the lever (32) is mounted so as to pivot on said stirrup-shaped piece (24), and extends between the straddling part and the button (23), then beyond the stirrup-shaped piece (24) to form said control portion.

3. Device according to claim 2, characterized in that the case (10) includes a tube (14) in which the push-piece (18) and the stem (16) are arranged, and in that said stirrup-shaped piece (32) is provided with a clamp (26) fixed to its two ends and surrounding and gripping said tube (14).

4. Device according to claim 1, characterized in that said push-piece (18) is formed of a tube surrounding said stem (16) and a first end of which is housed inside the case and a second end of which is located between the crown and the middle part and in that said lever (32) is inserted between said second end and said crown (20).

5. Device according to claim 4, characterized in that said middle part (12) is provided with a stud (12a) onto which said lever (32) is mounted so as to pivot.

6. Device according to any of claims 1 to 5, characterized in that the crown (20) and the push-piece (18) are disposed at 9 o'clock and the control portion (32c) in a zone comprised between 7 and 8 o'clock.
